(19) United States
(12) Patent Application Publication
(10) Pub. No.: US 2010/0039410 A1
(43) Pub. Date: Feb. 18, 2010

(54) DISTRIBUTED DISPLAY APPARATUS

(75) Inventors: Peter E. Becker, Coatesville, PA (US); Alain C. Briancon, Poolesville, MD (US); Ralph M. Mesmer, Banks, OR (US); Peter B. Ritz, Rydal, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: NTERA, INC., Radnor, PA (US)

(21) Appl. No.: 12/445,161

(22) PCT Filed: Oct. 12, 2007
(86) PCT No.: PCT/US07/21833

§ 371 Date: Oct. 12, 2009

Related U.S. Application Data
(60) Provisional application No. 60/829,229, filed on Oct. 12, 2006.

(51) Int. Cl. G09G 5/00; G09G 3/36

(52) U.S. Cl. 345/204; 345/87

(57) ABSTRACT

A distributed architecture for driving various electro-optic reflective display devices (620) is disclosed. Analog processors (6-15) are positioned in close proximity to the electro-optic reflective segments (650) being driven while digital processing functions are performed at a remote location. The analog and digital processors communicate via a bus (640). Various bus types and architectures for coupling the analog and digital processors are disclosed. The distributed architecture is particularly useful in electrochromic displays where the inherent properties of the display require analog sensing of each segment.

### FIELD OF INVENTION

The present invention generally relates to display devices. More particularly, the present invention relates to a logically or physically distributed display controller and driver for an electro-optic reflective display device.

### BACKGROUND

The optical properties of electro-optic reflective display devices depend on the electrical state of the display device. Selectively applying and removing charge to an electro-optic reflective display segment controls its optical properties. Moreover, electro-optic reflective display devices are reflective in nature. Reflective display devices, in contrast to emissive display technologies such as liquid crystal displays (LCDs), do not emit light. They instead reflect incident light and therefore perform exceptionally well in high ambient light environments, such as in natural sun light. Accordingly, electro-optic reflective displays do not require power hungry backlighting and are therefore well suited for mobile applications. Electrochromic displays, bistable LCDs, electrophoretic displays, electrowetting displays, nemoptic displays, cholesteric LCDs, dielectrophoresis displays, and anisotropically rotating ball displays are a few examples of electro-optic reflective display technologies.

Electro-optic reflective displays may consist of a single segment, such as an automatically dimming electrochromic rearview mirror, or multiple segments, such as an electrophoretic electronic book reader. In the case of multiple segment displays, a high resolution image may be displayed by selectively modulating light incident to a plurality of controlled segments. These segments may be controlled directly or in a matrix fashion (such as a passive matrix or a thin film transistor (TFT) active matrix).

Regardless of the architecture, in order to control and drive the individual segments, a controller and driver circuit is typically required. Prior art display drivers and controllers are typically application specific integrated circuits (ASICs) and include both digital and analog processing functionality. This kind of ASIC is termed a mixed signal ASIC, as both analog and digital signals are processed by the ASIC when the ASIC is active. This presents several disadvantages. First, digital and analog information is subject to cross-talk and substantial interference. Second, semiconductor process manufacturing techniques for purely digital designs and for purely analog designs are more advanced than techniques that support both designs. Third, of particular concern to printed electronics displays, the logic controlling a display might not be collocated with the display, allowing displays with limited electronics to be printed and deployed at a lower cost than an integrated system. Fourth, of particular concern to electrochromic display devices which, due to the inherent properties of electrochromic segments, require analog sensing at each segment, transmission of analog sensing data over longer distances results in line loss and degradation or interference of the analog signal.

Therefore, a display controller and driver having a distributed architecture that allows local placement of the analog component is desired.

### SUMMARY

A distributed architecture for driving various electro-optic reflective display devices is disclosed. Analog processors are positioned in close proximity to the electro-optic reflective segments being driven while digital processing functions are performed at a remote location. The analog and digital processors communicate via a bus. Various bus types and architectures for coupling the analog and digital processors are disclosed. The distributed architecture is particularly useful in electrochromic displays where the inherent properties of the display require analog sensing of each segment.

In a preferred embodiment, a wireless bus couples a host microcontroller with the analog processing functionality. Passive radio frequency identification (RFID) is preferably employed as the wireless bus, although other technologies are disclosed. The wireless bus carries data signaling, overhead signaling, and power to the analog processors.

### BRIEF DESCRIPTION OF THE DRAWINGS

A more detailed understanding of the invention may be had from the following description, given by way of example and to be understood in conjunction with the accompanying drawings, wherein:

FIG. 1 is a block diagram of an electro-optic reflective display driver architecture having a digital processor and a plurality of analog processors connected by way of a multi-drop bus;

FIG. 2 is a block diagram of an electro-optic reflective display driver architecture having a digital processor and a plurality of analog processors connected in a daisy-chain fashion;

FIG. 3 is a block diagram of an electro-optic reflective display driver architecture having a plurality of digital processors and a plurality of analog processors wherein both the digital and analog processing is distributed;

FIG. 4 is a block diagram of an electro-optic reflective display driver architecture having a plurality of digital processors and a plurality of analog processors wherein both the digital and analog processing is distributed, and each digital processor is associated with a group of analog processors by way of a multi-drop bus;

FIG. 5 is a block diagram of an electro-optic reflective display driver architecture having a plurality of digital processors and a plurality of analog processors wherein both the digital and analog processing is distributed, and each digital processor is associated with a group of analog processors in a daisy chain fashion;

FIG. 6 is a block diagram of an electro-optic reflective display driver architecture having distributed analog and digital components connected via a wireless bus, where the analog components are connected by way of a multi-drop bus; and

FIG. 7 is a block diagram of an electro-optic reflective display driver architecture having distributed analog and digital components connected via a wireless bus, where the analog components are connected in a daisy chain fashion.

### DETAILED DESCRIPTION OF THE PREFERRED EMBODIMENTS

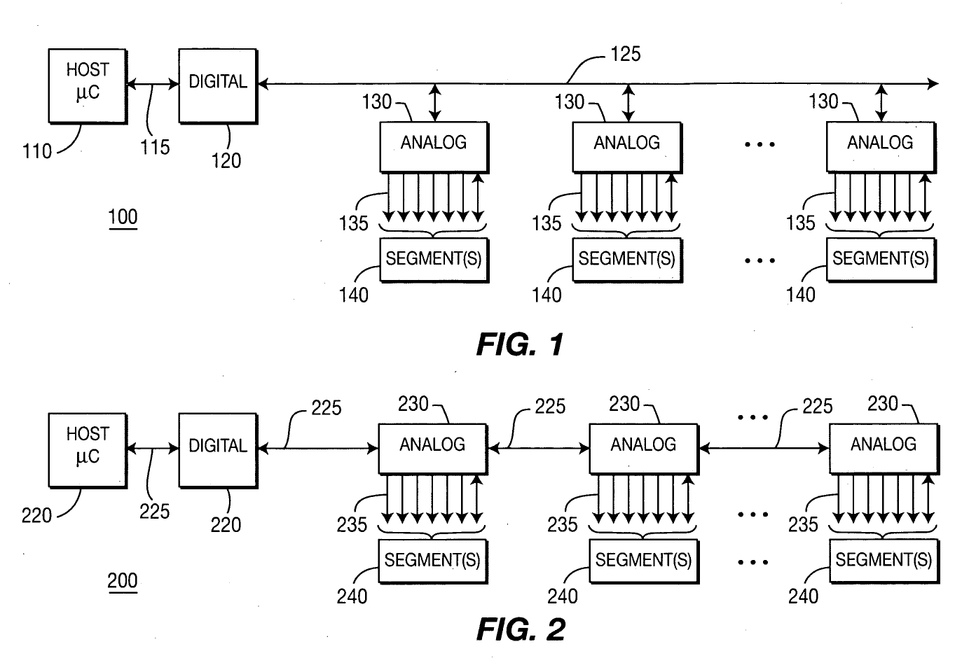

Referring to FIG. 1, a display driver architecture 100 includes distributed analog and digital components. A host microcontroller 110 communicates with a digital processor 120 via a serial bus 115. The serial bus 115 preferably carries all signaling necessary for driving display segments 140, including but not limited to data signals, overhead signals, clock signals, and the necessary power required to switch the segments 140 of the display. The digital processor 120 communicates with the plurality of analog processors 130 also by way of a bus 125.

Each analog processor 130 contains integrated driving functionality for driving a respective segment 140 or group of segments 140. Additionally, the analog processors 130 may contain digital to analog (D/A) and/or analog to digital (A/D) converters, logical circuitry, memory, analog sensing circuitry, and analog driving circuitry as needed. The analog processors 130 are preferably fabricated using materials that are favorable for analog circuitry, such as gallium arsenide (GaAS) or silicon germanium (SiGe), or organic TFT (OTFT) for printed electronics applications. Other materials may also be utilized in accordance with the teaching of the present invention.

The bus 125 logically connects and allows transfer of data and power from the digital processor 120 to the analog processors 130₁. The bus 125 is a multi-drop bus, and data carried over the bus 125 contains address information identifying the destination or source analog processor 130, as well as address information for a specific segment 140. Various bus protocols well known to those skilled in the art may be used, such as a serial peripheral interface (SPI) bus, or an inter-integrated circuit (I²C) bus, for example. The bus 125 allows the analog processors 130 to be located in close proximity to the segments 140 while the digital processor 120 may be remotely located. Various interconnecting cables may be utilized for the bus 125, with thin diameter, single cable styles being preferred. Printed circuitry may also be used. The bus 125 may be operational on a continuous or ad-hoc (when needed) basis.

Depending on the electro-optic reflective display technology in use, the analog processors 130 may also include sensing functionality (not specifically shown) for sensing the state of a respective segment or group of segments. The sensing functionality of the analog processors 130 preferably includes functionality to sense the electrochemical state within each respective segment 140 when electrochromic display technologies are selected. Feedback control of the segments 140 may be achieved by sensing the electrochemical state of each segment 140 or group of segments 140 and providing the state information to the digital processor 120. In addition to electrochemical state information, the analog processors 130 may include functionality for sensing various electrical, mechanical, optical, and environmental properties inside and outside of the display. For example, pressure, temperature, time, humidity, on time, on state, off time, off state, gradation level, voltage, current, charge, electromagnetic fields, electrokinetic effects, light, spectral shape, and chemical compounds may all be sensed by the sensors of the analog processors 130. Conditions of segments 140 sensed may be communicated from the analog processors 130 to the digital processor 120 for additional processing, and may even be communicated to the host microcontroller 110 for additional processing.

The digital processor 120 is typically a central processing unit (CPU) or digital ASIC. Preferably, it is fabricated using materials that are favorable for digital circuitry, such as a complimentary metal oxide semiconductor (CMOS) or bipolar junction CMOS transistors (biCMOS). The digital processor 120 preferably includes logical processing capabilities and memory for controlling the information displayed on the display as well as typical management functions. The digital processor 120 further processes the feedback information supplied by the sensors of the analog processors 130. Various feedback control techniques may be implemented by the digital processor 120 for controlling the segments based on the type of feedback information provided, which are well known to those skilled in the art.

The host microcontroller 110 may be any electronic device that requires a display for displaying information to a user. For example, host microcontroller 110 may be a mobile phone, MP3 player, transportation signage, fixed panel display, shelf label displays, as well as any other consumer electronics device that requires a display. In one embodiment, the segments 140 are shelf label displays for displaying price and product information in a retail environment, and the host microcontroller 110 is a computer workstation allowing central control of a plurality of display segments 140.

Referring to FIG. 2, an alternative distributed architecture 200 has the analog processors 230, such as those described above with reference to FIG. 1, daisy-chained together by way of a plurality of buses 225. In a daisy chain bus, data that is meant for an addressed processor is used by that processor while all other data is passed through the chain until it reaches the addressed processor. In both embodiments described above, the buses 125, 225 are preferably bi-directional buses, although a simple serial bus may also be used.

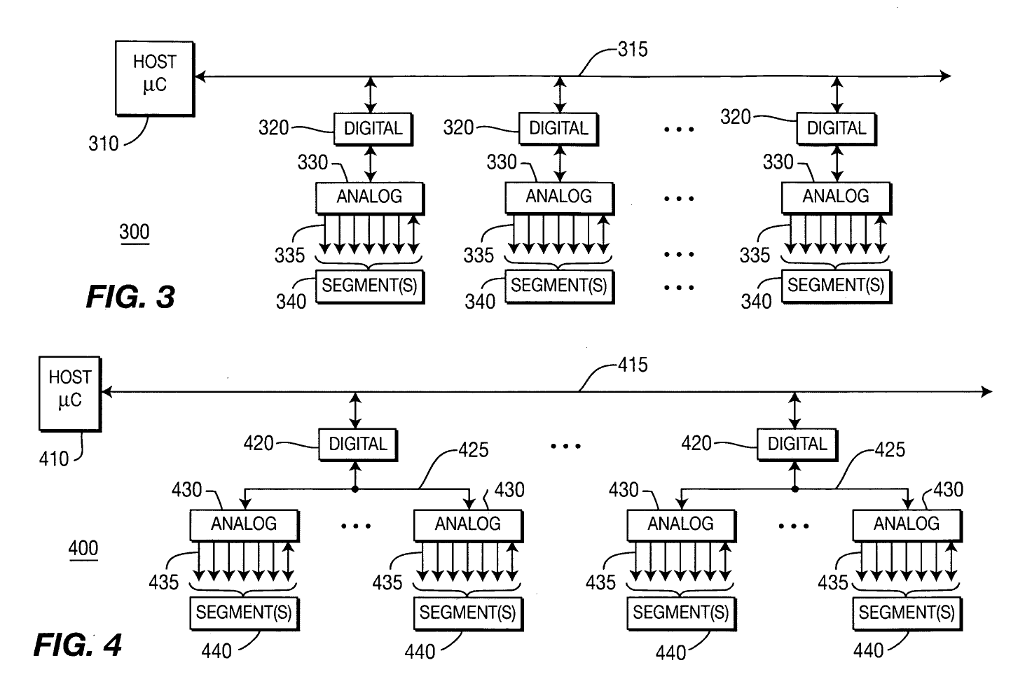

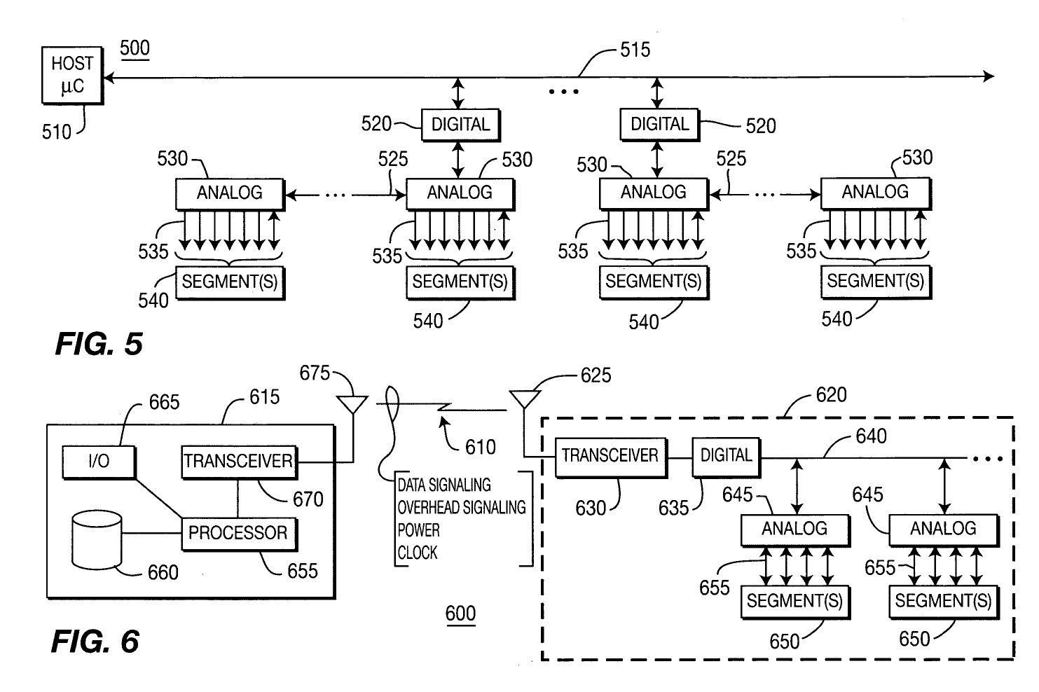

Alternatively, referring to FIG. 3, digital processing functionality is distributed to a plurality of digital processors 320, one for each analog processor 335. Segment sensors and drivers 335 communicate analog signals to and from each segment 340, as described above. While FIG. 3 shows one digital processor 320 associated with each analog processor 330, this is merely exemplary. A single digital processor 320 may be associated with a plurality of analog processors 330, as shown in FIGS. 4 and 5. Preferably, the digital processors 320 are fabricated using materials and techniques known for their ease of manufacturing, such as low temperature polysilicon or low voltage printable transistors.

FIG. 4 shows a plurality of digital processors 420 each controlling a plurality of analog processors 430 by way of a multi-drop bus. FIG. 5 shows a plurality of digital processors 520 each controlling a plurality of analog processors 530 connected in a daisy chain fashion. The embodiments described in FIGS. 3, 4, and 5 are particularly suited for controlling matrix displays, such as passive or active matrix displays. For example, each row or column of a matrix addressed display may be controlled by a single digital processor. Alternatively, a subset of analog controllers, and therefore segments, may be controlled by a single digital processor. For example, every i^{th} segment in both a vertical and horizontal direction may be controlled by a particular digital processor. In this manner, a plurality of digital processors would be associated with segments dispersed throughout the entire display surface.

The various embodiments described above with reference to FIGS. 1 through 4 are illustrative, and could be used in any combination to achieve a desirable driving architecture for a specific display implementation. Nevertheless, the distributed nature of the analog and digital components connected by a bus carrying data, overhead, clock, and power signaling provides great advantages over prior art driving architectures.

In addition to the above described wired bus technologies, wireless, optical, radio frequency identification (RFID), both passive and active, inductive coupling, and proximity based communications links may also be used. These alternatives allow remote wireless location of display devices, and the possibility of a portable centralized host microcontroller that is capable of switching the display segments in a wireless fashion. For example, where the electro-optic reflective display devices are retail outlet shelf labels, a portable wireless host microcontroller may be used to adjust the segments of each display to reflect changing prices and product descriptions.

Referring to FIG. 6, a distributed driving architecture 600 includes a wireless bus 610 for wirelessly connecting a host microcontroller 615 and a display device 620. Display device 620 includes an antenna 625 and a transceiver unit 630 for receiving display information from the host microcontroller 615. A digital processor 635 communicates digital information with the host microcontroller 615 via the transceiver 630 and wireless bus 610. Analog processors 645 communicate with the digital processor 635 via a multi-drop bus 640 as described above with reference to FIG. 1, however this is merely exemplary and any of bus arrangement may be used as desired, such as the architectures described above with reference to FIGS. 1 through 5. A segment or group of segments 650 are driven and sensed, as needed, via segment drivers and sensors 655.

The host microcontroller 615 includes a processor 655, a memory 660, an input/output (I/O) component 665, a transceiver 670, and an antenna 675. The processor 655 can be any type of processor and is generally configured to control the components of the host microcontroller 615. The memory 660 stores pre-programmed display information as well as typical operating information for the host microcontroller 615. The I/O component 665 allows a user of the host microcontroller 615 to interface with the device. The I/O component 665 may include a display and data entry interface as desired. The transceiver 670 and antenna 675, in combination with the antenna 625 and transceiver 630 of the display device 620, form the wireless bus 610 coupling the host microcontroller 615 with the display device 620. The structure of the transceivers 630, 670 and antennas 625, 675 will depend on the underlying technology used for the wireless bus 610.

In one illustrative embodiment, the wireless bus 610 utilizes RFID technology. When the display is integrated with a passive RFID, the wireless bus 610 not only carries data signaling, such as data relating to the desired image to be displayed by the segment(s) 650, and overhead signaling, such as segment address information and framing, but the wireless bus 610 also functions to power the logic in the digital processor 635 and to drive the display segments(s) 650. When used in combination with electrochromic displays, which are inherently very low power devices, the power induced at the RFID transceiver 630 from the transmitted RFID signal would be sufficient to power the analog processors 635 and sense and drive the segment(s) 650. Alternatively, an active RFID system may be used where the display device 620 includes its own power supply (not shown).

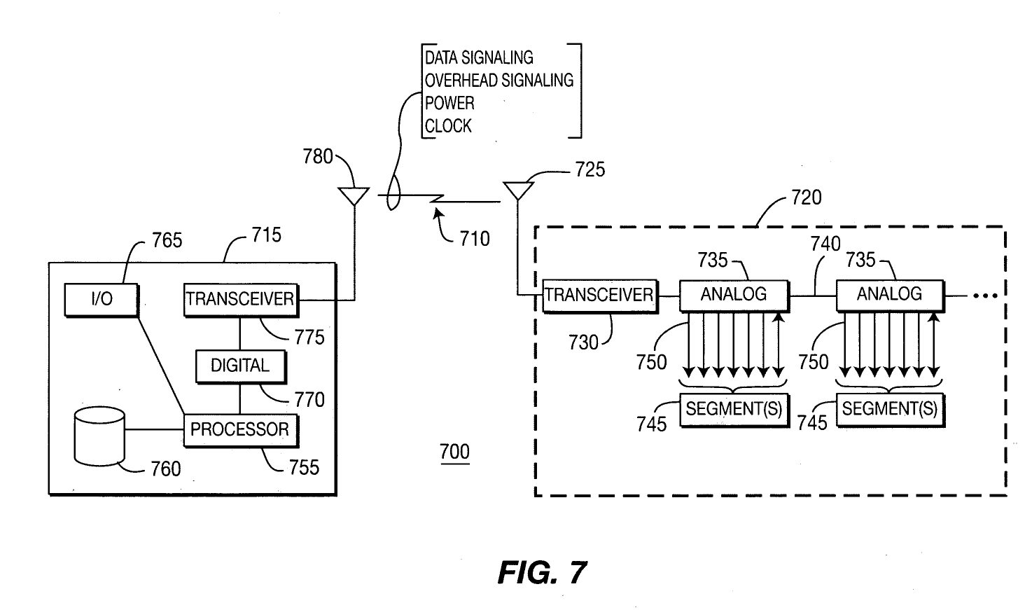

Referring to FIG. 7, a distributed driving architecture 700 again includes a wireless bus 710 for wirelessly connecting a host microcontroller 715 and a display device 720. Display device 720 includes an antenna 725 and a transceiver 730 for receiving display information from the host microcontroller 715. Analog processors 735 communicate via bus 740 and are arranged in a daisy chain fashion, however this is merely exemplary and any bus arrangement may be used as desired, such as the architectures described above with reference to FIGS. 1 through 5. A display segment 745 or group of segments are sensed and driven via display drivers and sensors 750.

In the architecture 700 shown in FIG. 7, the digital processing functionality resides in digital processor 770 located in the host microcontroller 715. Only analog processors 735 are present in the display device 720, thereby enabling a very low cost, easily manufactured display device that may be remotely controlled via a wireless bus. As mentioned above, this distributed analog and digital functionality allows close placement of analog functionality with the display segments.

Transceiver 730 of the display device 720 communicates with transceiver 775 of the host microcontroller 715 via the wireless bus 710 and antennas 725, 780. The digital processor 770 located in the host microcontroller 715 performs all digital processing associated with driving and sensing the display segment(s) 745.

The host microcontroller 715 further includes a processor 755, a memory 760, and an input/output (I/O) component 765. The processor 755 can be any type of processor and is generally configured to control the components of the host microcontroller 715. The memory 760 stores pre-programmed display information as well as typical operating information for the host microcontroller 715. The I/O component 765 allows a user of the host microcontroller 715 to interface with the device. The I/O component 765 may include a display and data entry interface as desired. The transceiver 770 and antenna 775, in combination with the antenna 725 and transceiver 730 of the display device 720, form the wireless bus 710 coupling the host microcontroller 715 with the display device 720. The structure of the transceivers 730, 770 and antennas 725, 775 will depend on the underlying technology used for the wireless bus 710.

The architectures described above with reference to FIGS. 6 and 7 show a multi-drop bus and a daisy chain bus, respectively, coupling the analog and digital processors. It will be obvious to those of ordinary skill in the art that these architectures are exemplary and any combination of digital and analog circuitry may be used, such as those described above with reference to FIGS. 1 through 5. Likewise, architectures having digital processing functionality of the driving and sensing the display segment(s) may be places in either the host microcontroller or the display device in any combination with the bus architectures described herein as well as those known generally in the art. Moreover, an architecture having a one-to-one correspondence between analog and digital processors is within the scope of this disclosure. In all conceivable embodiments, the distributed nature of the analog and digital processing functionality and the wireless bus communicating data signaling, overhead signaling, clock signals, and power between the host microcontroller and the digital processor(s) provides close placement of analog processing functionality with the display segment(s) and allows remote placement of digital processing functionality.

In all embodiments described herein, a security overlay may be implemented to secure data communicated between the digital and analog processors. This is particularly important when a wireless bus is used. Data may be encrypted prior to transmission over the wireless bus. Various encryption techniques will be apparent to those of skill in the art. The selected encryption technique is not critical to the invention, simply that communications transmitted over a wireless link are encrypted. Additionally, key based challenges may be utilized for authenticating each end of the wireless link, and restriction of functionality at either the digital or analog processor, or both, is possible based on a trust level negotiated between the transmission ends.

In all of the embodiments described herein, the analog processors are preferably placed in close proximity to an associated segment. The analog processors may be located on the display substrate itself, allowing the digital processor to be located elsewhere. A chip-on-substrate (COS) technique may be employed for placing the analog processors on the display substrate. It should also be noted that the display substrate may be a variety of materials, ranging from glass, plastic and other traditional display substrates to wood, metal, and various fabrics.

Although the features and elements of the present invention are described in the preferred embodiments in particular combinations, each feature or element can be used alone without the other features and elements of the preferred embodiments or in various combinations with or without other features and elements of the present invention.

### EMBODIMENTS

1. A display driver for pixilated display devices having at least one pixel, the driver comprising:
a digital processor; and
at least one analog processor coupled to the digital processor, the analog processor comprising:
   analog circuitry configured for driving the pixel; and
   analog circuitry configured for sensing properties of the pixel.

2. The display driver of embodiment 1, comprising at least one analog processor for each pixel of the display device.

3. The display driver of embodiment 2, further comprising:
a bus for electrically connecting the at least one analog processor to the digital processor.

4. The display driver of embodiment 3, wherein the bus is a multi-drop bus.

5. The display driver of embodiment 3, wherein the bus is a daisy chain bus.

6. A display driver according to any of embodiments 3-5, wherein the bus is a serial communication bus.

7. The display driver of embodiment 1, wherein each analog processor is associated with a plurality of pixels.

8. A display driver for pixilated display devices having at least one pixel, the driver comprising:
at least one digital processor; and
at least one analog processor coupled to a digital processor, the analog processor comprising:
   analog circuitry configured for driving the pixel; and
   analog circuitry configured for sensing properties of the pixel.

9. The display driver of embodiment 8, comprising at least one analog processor for each pixel of the display device.

10. The display driver of embodiment 8, wherein each analog processor is associated with a plurality of pixels.

11. A display driver according to any of embodiments 9-10, comprising at least one digital processor for each analog processor.

12. The display driver of embodiment 9, comprising one digital processor for a plurality of analog processors.

13. A display driver according to any of embodiments 8-12, further comprising:
a bus for electrically connecting each analog processor to a respective digital processor.

14. The display driver of embodiment 13, wherein the bus is a multi-drop bus.

15. The display driver of embodiment 13, wherein the bus is a daisy chain bus.

16. A display driver according to any of embodiments 13-15, wherein the bus is a serial communications bus.

17. A display driver according to any of the preceding embodiments 1-7, wherein the digital processor comprises a central processing unit (CPU).

18. A display driver according to any of embodiments 1-7, wherein the digital processor comprises a microprocessor.

19. A display driver according to any of embodiments 8-16, wherein the digital processor comprises a central processing unit (CPU)

20. A display driver according to any of embodiments 3-7, and 13-16, wherein the bus is a wireless bus.

21. A display driver according to any of embodiments 3-7, and 13-16, wherein the bus is an optical link bus.

22. A display driver according to any of embodiments 3-7, and 13-16, wherein the bus is a passive radio frequency identification (RFID) bus.

23. A display driver according to any of embodiments 3-7, and 13-16, wherein the bus is an active RFID bus.

24. A display driver according to any of embodiments 3-7, and 13-16, wherein the bus is a proximity based communications bus.

25. A display driver according to any of embodiments 3-7. 13-16 and 20-24, wherein data exchange over the bus is subject to a security overlay.

26. The display driver of embodiment 25, wherein the security overlay includes encrypting at least part of the data exchanged over the bus.

27. A display driver according to any of embodiments 25-26, wherein the security overlay includes key based authentication challenges.

28. A display driver according to any of embodiments 25-27, wherein the security overlay includes restriction of bus functionality.

29. A display driver according to any of the preceding embodiments, wherein each analog processor is physically attached to a display substrate.

30. The display driver of embodiment 29, wherein the physical attachment is achieved using a chip-on-substrate assembly.

31. A display driver according to any of the preceding embodiments, wherein a display substrate is rigid.

32. A display driver according to any of the preceding embodiments, wherein the display substrate is flexible.

33. A display driver according to any of the preceding embodiments, wherein the analog circuitry configured for sensing physical properties of the pixel is further configured to sense electrical characteristics inside the display.

34. A display driver according to any of the preceding embodiments, wherein the analog circuitry configured for sensing physical properties of the pixel is further configured to sense mechanical characteristics inside of the display.

35. A display driver according to any of the preceding embodiments, wherein the analog circuitry configured for sensing physical properties of the pixel is further configured to sense mechanical characteristics outside of the display.

36. A display driver according to any of the preceding embodiments, wherein the analog circuitry configured for sensing physical properties of the pixel is further configured to sense optical characteristics inside of the display.

37. A display driver according to any of the preceding embodiments, wherein the analog circuitry configured for sensing physical properties of the pixel is further configured to sense optical characteristics outside of the display.

38. A display driver according to any of the preceding embodiments, wherein the analog circuitry configured for sensing physical properties of the pixel is further configured to sense at least one property from the group consisting of: pressure, temperature, time, humidity, on time, on state, off time, off state, gradation level, voltage, current, charge, electromagnetic fields, electrokinetic effects, light, spectral shape, and chemical compounds.

39. A display driver according to any of the preceding embodiments, for use with a host.

40. The display driver of embodiment 39, wherein the host is selected from the group consisting of: electronic displays, input devices, control devices, shelf-edge labels, optical components, camouflage implements, shoes, clothing, MP3 players, mobile phones, large area static displays, consumer electronics' displays, and video displays.

41. A display driver according to any of the preceding embodiments, wherein the bus is established on a ad-hoc/as needed basis.

42. A display system comprising:
a segmented electro-optic reflective display device comprising:
   an electro-optic reflective display segment;
   an analog processor coupled to the electro-optic reflective display segment configured to drive the electro-optic reflective display segment; and
   a digital processor coupled to the analog processor.

43. The display system of embodiment 42, wherein the digital processor is configured to receive at least one of data signals, overhead signals, and clock signals for use in controlling the analog processor.

44. A display system according to embodiment 42 or 43, further comprising:
a host micro-controller comprising:
   a memory configured to store data for use in driving an electro-optic reflective display segment; and
   a processor configured to generate at least one of data signals, overhead signals, and clock signals for use in driving the segment.

45. The display system of embodiment 44, further comprising:
a wireless bus.

46. The display system of embodiment 45, wherein the wireless bus is configured to communicate at least one of data signals, overhead signals, and clock signals for driving the segment from the processor of the host micro-controller to the digital processor of the segmented electro-optic reflective display device.

47. A display system according to any of embodiments 42-46, wherein the analog processor is further configured to sense at least one physical property of the segment.

48. A display system according to embodiments 45 or 46, wherein the wireless bus is further configured to carry power for driving a display segment.

49. The display system of embodiment 48, wherein power is provided by way of inductive coupling.

50. A display system according to any of embodiments 45-49, wherein the wireless bus uses passive radio frequency identification (RFID).

51. A display system according to any of embodiments 45-50, wherein the wireless bus is established on an ad-hoc basis.

52. A display system according to any of embodiments 45-51, wherein signaling exchanged over the wireless bus is protected by a security overlay.

53. A display system according to any of embodiments 42-52, wherein the analog processor is collocated with the segment, and the digital processor is located in a different location.

54. A display system comprising:
a segmented electro-optic reflective display device comprising:
   an electro-optic reflective display segment; and
   an analog processor coupled to the electro-optic reflective display segment configured to drive the electro-optic reflective display segment.

55. The display system according to embodiment 54, further comprising:
a host micro-controller comprising:
   a memory configured to store data for use in driving an electro-optic reflective display segment; and
   a digital processor configured to generate at least one of data signals, overhead signals, and clock signals for use in driving the segment.

56. The display system of embodiment 55, further comprising:
a wireless bus.

57. The display system of embodiment 56, wherein the wireless bus is configured to communicate at least one of data signals, overhead signals, and clock signals for driving the segment from the processor of the host micro-controller to the digital processor of the segmented electro-optic reflective display device.

58. A display system according to any of embodiments 54-57, wherein the analog processor is further configured to sense at least one physical property of the segment.

59. A display system according to embodiments 56 through 58, wherein the wireless bus is further configured to carry power for driving a display segment.

60. The display system of embodiment 59, wherein power is provided by way of inductive coupling.

61. A display system according to any of embodiments 56-60, wherein the wireless bus uses passive radio frequency identification (RFID).

62. A display system according to any of embodiments 56-61, wherein the wireless bus is established on an ad-hoc basis.

63. A display system according to any of embodiments 56-62, wherein signaling exchanged over the wireless bus is protected by a security overlay.

64. A display system according to any of embodiments 54-63, wherein the analog processor is collocated with the segment, and the digital processor is located in a different location.

What is claimed is:

1. A display driver for a segmented electro-optic reflective display device having a segment, the driver comprising:
a digital processor;
an analog processor comprising:
analog circuitry adapted to drive a segment; and
analog circuitry adapted to sense a property of a segment; and
a bus adapted to couple the digital processor with the analog processor, wherein the bus carries data signals, overhead signaling, and a clock signal.

2. The display driver of claim 1, wherein the bus further carries power for driving a segment.

3. The display driver of claim 1, comprising at least one analog processor for each segment of the display device.

4. The display driver of claim 1, wherein the bus is a multi-drop bus.

5. The display driver of claim 1, wherein the bus is a daisy chain bus.

6. The display driver of claim 1, wherein the bus is a wireless bus.

7. The display driver of claim 6, wherein the wireless bus is configured to carry power for driving a segment by way of inductive coupling.

8. The display driver of claim 7, wherein the wireless bus uses passive radio frequency identification (RFID).

9. The display driver of claim 6, wherein the wireless bus is established on an ad-hoc basis.

10. The display driver of claim 6, wherein signaling exchanged over the wireless bus is protected by a security overlay.

11. The display driver of claim 6, wherein the analog processor is collocated with the segment, and the digital processor is located in a different location.

12. A display system comprising:
a segmented electro-optic reflective display device comprising:
an electro-optic reflective display segment;
an analog processor coupled to the electro-optic reflective display segment configured to drive the electro-optic reflective display segment; and
a digital processor coupled to the analog processor configured to receive data signals, overhead signals, and clock signals for use in controlling the analog processor;
a host micro-controller comprising:
a memory configured to store data for use in driving an electro-optic reflective display segment; and
a processor configured to generate data signals, overhead signals, and clock signals for use in driving the segment; and
a wireless bus configured to communicate data signals, overhead signals, and clock signals for driving the segment from the processor of the host micro-controller to the digital processor of the segmented electro-optic reflective display device.

13. The display system of claim 12, wherein the analog processor is further configured to sense at least one physical property of the segment.

14. The display system of claim 12, wherein the wireless bus is further configured to carry power for driving a display segment by way of inductive coupling.

15. The display system of claim 14, wherein the wireless bus uses passive radio frequency identification (RFID).

16. The display system of claim 14, wherein the wireless bus is established on an ad-hoc basis.

17. The display system of claim 14, wherein signaling exchanged over the wireless bus is protected by a security overlay.

18. The display system of claim 14, wherein the analog processor is collocated with the segment, and the digital processor is located in a different location.

19. A display system comprising:
a segmented electro-optic reflective display device comprising:
an electro-optic reflective display segment; and
an analog processor coupled to the electro-optic reflective display segment configured to drive the electro-optic reflective display segment;
a host micro-controller comprising:
a memory configured to store data for use in driving an electro-optic reflective display segment; and
a digital processor configured to generate data signals, overhead signals, and clock signals for use in controlling the analog processor; and
a wireless bus configured to communicate data signals, overhead signals, and clock signals for driving the segment from the digital processor of the host micro-controller to the analog processor of the segmented electro-optic reflective display device.

20. The display system of claim 19, wherein the analog processor is further configured to sense at least one physical property of the segment.

21. The display system of claim 19, wherein the wireless bus is further configured to carry power for driving a display segment by way of inductive coupling.

22. The display system of claim 19, wherein the wireless bus uses passive radio frequency identification (RFID).

23. The display system of claim 19, wherein the wireless bus is established on an ad-hoc basis.

24. The display system of claim 19, wherein signaling exchanged over the wireless bus is protected by a security overlay.

25. The display system of claim 19, wherein the analog processor is collocated with the segment and the digital processor is located in a different location.
